(19) United States
(12) Patent Application Publication
(10) Pub. No.: US 2026/0170559 A1
(43) Pub. Date: Jun. 18, 2026

(54) SYSTEM AND METHOD FOR AUTOMATED FINANCIAL MANAGEMENT FOR MULTI-USER BUDGETING

(71) Applicant: William Roy Glover, III, Berlin, NH (US)

(72) Inventors: William Roy Glover, III, Berlin, NH (US); Thomas David Abert, Stoddard, NH (US); Maria Elena Teigeiro, Beverly, MA (US)

(21) Appl. No.: 19/355,361

(22) Filed: Oct. 10, 2025

Related U.S. Application Data
(60) Provisional application No. 63/732,995, filed on Oct. 12, 2024.

(51) Int. Cl. G06Q 40/06; G06Q 40/02

(52) U.S. Cl. CPC G06Q 40/065; G06Q 40/0222

(57) ABSTRACT

One variation of a method includes: accessing a financial statement of a first user of a first authority level, the financial statement defining a set of expenses; extracting a set of language signals from the financial statement; based on the set of language signals, identifying a set of discretionary expenses in the set of expenses and identifying a set of non-discretionary expenses in the set of expenses; and, based on the set of expenses, predicting a budget deficit. The method further includes, in response to the budget deficit falling within a first deficit range: identifying a discretionary expense, in the set of discretionary expenses, corresponding to the budget deficit; generating an electronic notification describing the budget deficit and the discretionary expense; and transmitting the electronic notification to a second user affiliated with the first user, the second user of a second authority level exceeding the first authority level.

### CROSS-REFERENCE TO RELATED APPLICATIONS

This Application claims the benefit of U.S. Provisional Application No. 63/732,995, filed on 12 Oct. 2024, which is incorporated in its entirety by this reference.

### TECHNICAL FIELD

This invention relates generally to the field of automated financial management systems and, more specifically, to a new and useful system and method for multi-user budgeting in the field of automated financial management systems.

### BRIEF DESCRIPTION OF THE FIGURES

FIG. 1 is a schematic representation of a method;

FIG. 2 is a schematic representation of one variation of the method;

FIG. 3 is a schematic representation of one variation of the method;

FIG. 4 is a schematic representation of one variation of the method;

FIGS. 5A, 5B, and 5C are schematic representations of one variation of the method; and

FIG. 6 is a schematic representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method: Asymmetric Users+Deficit Prediction

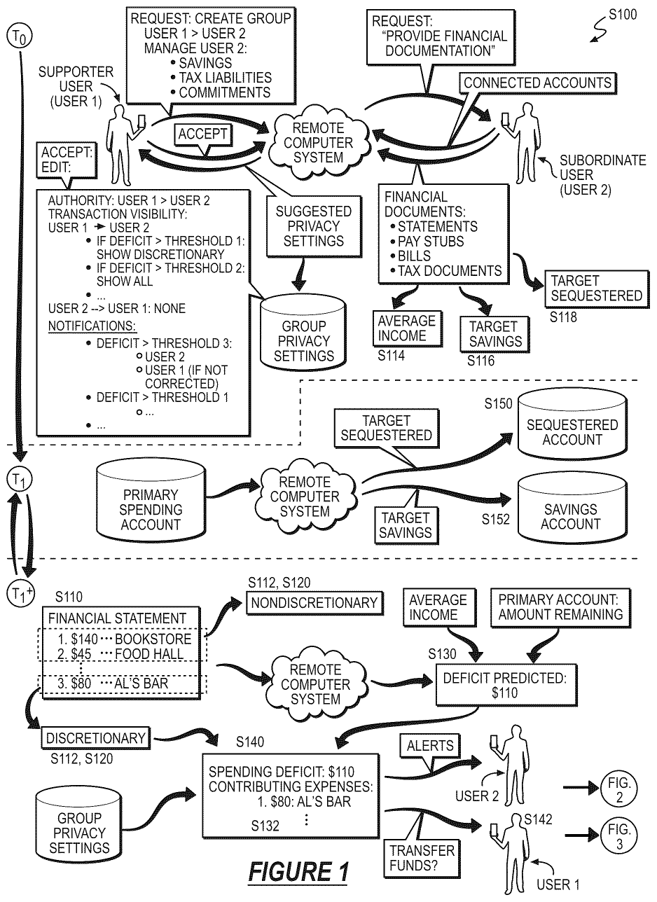

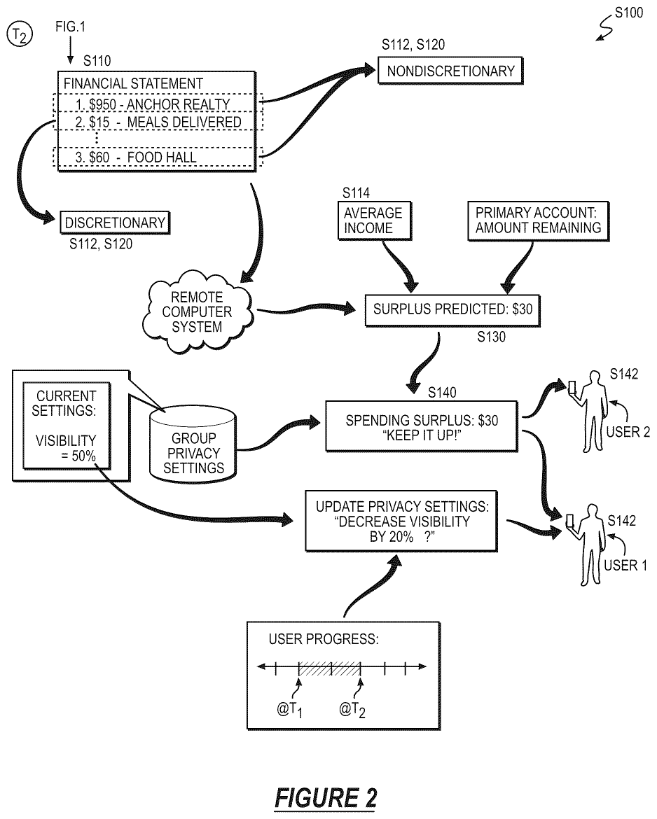

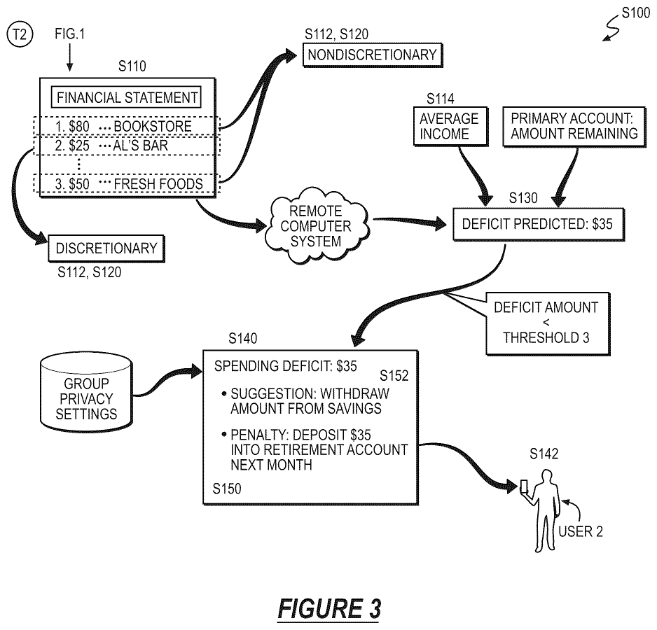

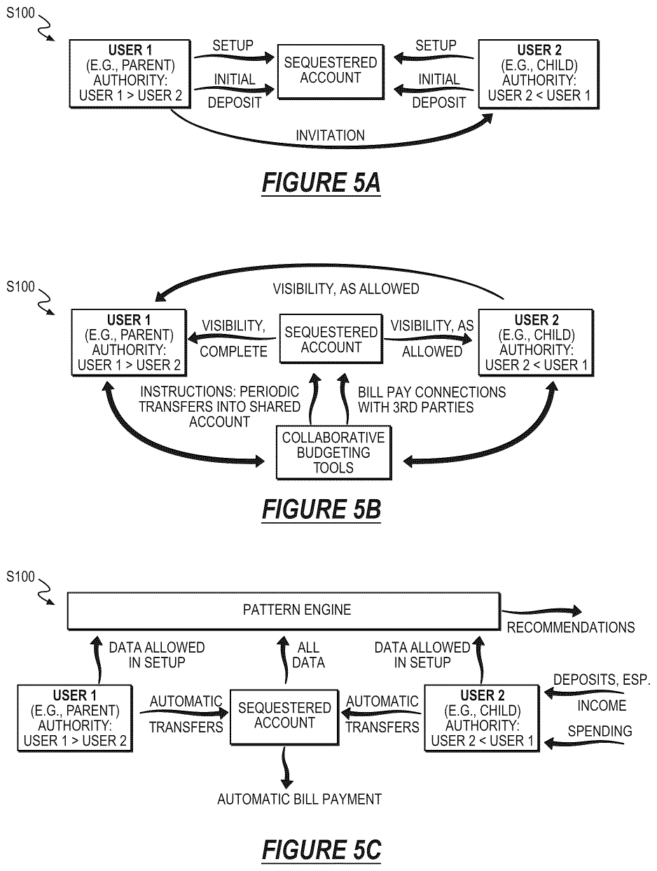

As shown in FIGS. 1-3, 5A, 5B, 5C, and 6, a method S100 includes: accessing a first financial statement of a first user of a first authority level, the first financial statement defining a first set of expenses initiated by the first user during a first time period in Block S110; extracting a first set of language signals from the first financial statement in Block S112; based on the first set of language signals, identifying a first set of discretionary expenses in the first set of expenses and identifying a first set of non-discretionary expenses in the first set of expenses in Block S120; and, based on the first set of discretionary expenses and the first set of non-discretionary expenses, predicting a first budget deficit within a second time period succeeding the first time period in Block S130.

The method S100 further includes, in response to the first budget deficit falling within a first deficit range: identifying a first discretionary expense, in the first set of discretionary expenses, corresponding to the first budget deficit based on the first set of language signals in Block S132; generating a first electronic notification describing the first budget deficit and the first discretionary expense in Block S140; and transmitting the first electronic notification to a second user affiliated with the first user, the second user of a second authority level exceeding the first authority level in Block S142.

### 1.1 Method: Deficit Prediction+Surplus Prediction

As shown in FIGS. 1-3, 5A, 5B, and 5C, one variation of the method S100 includes, during a first time period: accessing a first financial statement of a first user, the first financial statement comprising a first set of expenses initiated by the first user in Block S110; and, based on the first set of expenses, predicting a first budget deficit occurring during the first time period in Block S130. The method S100 further includes, during the first time period, in response to the first budget deficit falling within a first deficit range: identifying a first set of discretionary expenses, in the first set of expenses, corresponding to the first budget deficit based on a first set of language signals extracted from the first financial statement in Block S132; generating a first electronic notification describing the first budget deficit and the first set of discretionary expenses in Block S140; and transmitting the first electronic notification to a second user affiliated with the first user,

In this variation, the method S100 further includes, during a second time period succeeding the first time period: accessing a second financial statement of the first user, the second financial statement comprising a second set of expenses initiated by the first user in Block S110; and, based on the second set of expenses, predicting a first budget surplus during the second time period in Block S130. The method S100 further includes, during the second time period, in response to predicting the first budget surplus: generating a second electronic notification describing the first budget surplus and excluding description of the second set of expenses in Block S140; and transmitting the second electronic notification to the second user in Block S142.

### 1.2 Method: Goal Setting

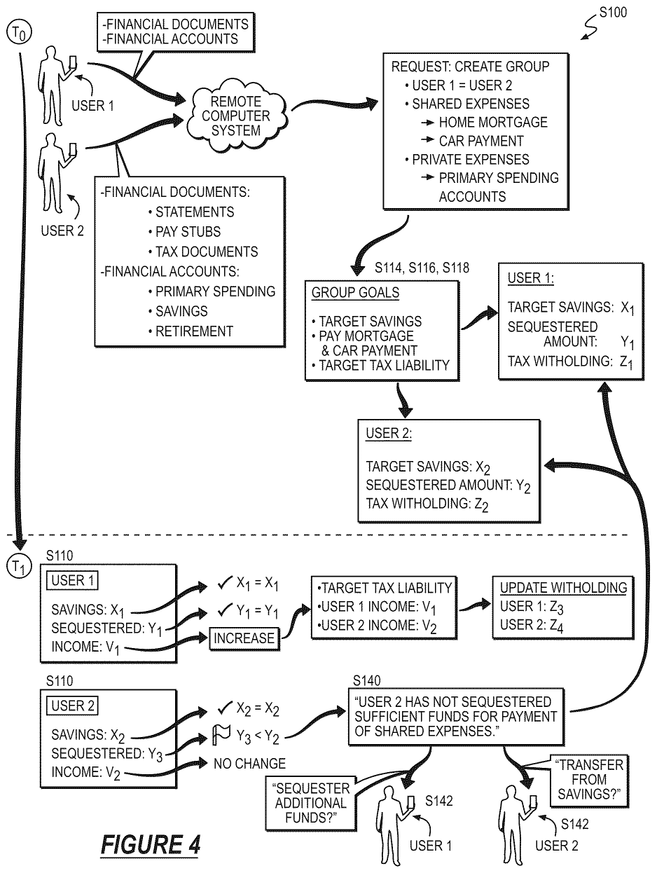

As shown in FIGS. 1, 2, 4, 5A, 5B, and 5C, one variation of the method S100 includes: accessing an expected income defined for a first user during a first time period in Block S114; accessing a target savings amount defined for the first user during the first time period in Block S116; and accessing a set of committed expenses predefined for the first time period for the first user in Block S118. The method S100 further includes, during the first time period: at a first time, transferring the target savings amount from a primary account affiliated with the first user to a savings account affiliated with the first user in Block S152; at a second time, sequestering a first financial amount, from the primary account, allocated for payment of the set of committed expenses in Block S150; tracking a timeseries of expenses initiated by the first user in Block S110; and, based on the expected income, the timeseries of expenses, and a first financial amount remaining in the primary account, predicting a spending deficit of a first deficit amount at a third time, succeeding the first time and the second time, during the first time period in Block S130. The method S100 further includes, in response to predicting the spending deficit of the first deficit amount, accessing a second financial amount remaining in the savings account and in response to the second financial amount remaining in the savings account exceeding the first deficit amount: generating a prompt to transfer the first deficit amount from the savings account into the primary account; assigning a first penalty to the first deficit amount transferred from the savings account into the primary account in Block S160; generating an electronic notification including the prompt and describing the first penalty in Block S140; and transmitting the electronic notification to the first user in Block S142.

### 2. Applications

Generally, Blocks of the method S100 can be executed by a remote computer system to: automatically sequester funds from a user's primary spending account for payment of financial commitments (e.g., bills, rent, subscription fees) during a payment period; track the user's spending during the payment period; selectively predict instances of spending deficits during the payment period based on an amount of funds available to the user—excluding the sequestered amount of funds—in the user's primary spending account, the user's tracked spending, and/or an expected or predicted income of the user during the payment period; and selectively notify the user—and/or a supporter user exhibiting authority over the user—of predicted deficits and/or expenses contributing toward these predicted deficits.

In particular, the computer system can promote joint management (or team management) of a financial account of a subordinate user's finances by both the subordinate user and a supporter user exhibiting authority over the subordinate user. In one implementation, the computer system can: track expenses initiated by the supporter user over time; and selectively serve electronic notifications—indicating budget deficits, budget surpluses, changes in the subordinate user's spending habits, etc.—to both the subordinate user (e.g., a child) of a first authority level and the supporter user (e.g., a parent) of a second authority level exceeding the first authority level. 3

For example, during a spending period, the computer system can: deposit a target savings amount into the subordinate user's savings account; sequester a financial amount—such as in a sequestered account accessible by the supporter user—required to cover payment of the set of committed expenses; automatically execute payment of the set of committed expenses from the sequestered account; and track timeseries expenses initiated by the subordinate user during the spending period. Based on these timeseries expenses, the computer system can selectively expose income streams and/or expenses—such as including discretionary and/or nondiscretionary expenses—initiated by the subordinate user to the supporter user, and/or selectively prompt the supporter user to provide funds to the subordinate user. For example, in response to the subordinate user overspending—and thus experiencing a spending deficit—the computer system can: present minimum information necessary to the supporter user in response to the spending deficit corresponding to a nondiscretionary expense (e.g., tuition, rent) and/or in response to the spending deficit falling below a threshold; and
present more information to the supporter user in response to the spending deficit corresponding to a discretionary expense (e.g., eating out, subscription services) and/or in response to the spending deficit exceeding the threshold.

Furthermore, the computer system can automatically sequester funds assigned to various expenses during the payment period. For example, the computer system can sequester a financial amount corresponding to a committed expense (e.g., a recurring expense) and/or sequester a financial amount corresponding to a target savings goal defined for the user. The computer system can then store these funds in the user's savings account and/or in a separate sequestered account generated for the user. Therefore, the computer system can ensure availability of payment for these committed expenses during the payment period. Furthermore, the computer system can enable the supporter user to view and thus confirm sequestration of funds for these expenses and final payment toward these expenses by the subordinate user.

Furthermore, in response to the user withdrawing from sequestered funds and/or funds applied toward the user's target savings, the computer system can assign a penalty—such as a value (e.g., a percentage, a fixed amount) of interest for repayment of these funds into the savings account and/or a fixed amount for payment into a retirement fund affiliated with the subordinate user—during future time windows as a penalty for not meeting the target savings amount for this time window and/or withdrawing from sequestered funds. For example, the computer system can require the subordinate user to deposit a financial amount—equivalent to and/or proportional to a withdrawal amount from the sequestered funds—into a “penalty” account generated for the subordinate user. Therefore, the computer system can: “penalize” the user for deviating from budgeting goals without requiring payment of penalties to an external party; and enable the user to repay this amount to herself (e.g., with interest in the future) and, therefore, replenish the savings and/or sequestered account, thereby promoting reduced spending and increased saving by the user.

### 3. User Portal

Generally, the computer system interfaces with a user portal executing on a computing device accessed by a user. In particular, the computer system can render instances of the user portal in a web browser or through a dedicated application (e.g., a native application) executing on the computing device (e.g., a smartphone, a tablet, a desktop computer, a laptop computer). The computer system can then: render relevant financial information to user within instances of the user portal; and selectively serve notifications—indicating status of user finances—to users via instances of the user portal.

In one implementation, the computer system can interface with multiple instances of the user portal—each instance of the user portal assigned to an unique user—associated with a shared financial account. For example, the computer system can: interface with a first instance of a user portal executing on a first user device (e.g., a smart phone, a tablet, a desktop computer) accessed by a first user; and interface with a second instance of the user portal executing on a second user device accessed by a second user associated with the first user. The computer system can: link the first instance of the user portal to the second instance of the user portal based on inputs provided by the first and/or second user; and selectively serve notifications to the first and second users—via the first and second instances of the user portal—based on financial status of the first and/or second user and/or based on settings selected by these users.

### 4. Onboarding

Generally, the computer system can prompt the user to generate a user profile within the user portal. For example, the user may download a native application to her smartphone or navigate to a web application within a browser executing on her smartphone. The computer system can then: generate a prompt to initialize a user profile within the application and manually populate the user profile with various information, such as a name, age, job description, income, etc.; and transmit the prompt to the user.

Additionally or alternatively, in another example, the computer system can automatically populate the user profile with information extracted from one or more financial documents provided by the user and/or via extraction of financial information from one or more financial accounts linked by the user. For example, in response to the user generating the user profile, the computer system can: generate a prompt to upload a set of financial documents affiliated with the user, such as including a set of recent pay stubs, a set of tax documents (e.g., a form W-2, a form 1099), a set of bank statements, a set of monthly bills, etc.; transmit the prompt to the user via the user portal; and, in response to receiving the set of financial documents from the user, extract a set of user information from the set of financial documents—such as including the user's name, date of birth, age, income, tax bracket, average monthly spend, job title, etc.—and populate the user profile accordingly.

In one implementation, the computer system can prompt the user to connect with another user to enable joint management and/or review of finances. For example, in this implementation, the computer system can: implement the steps above to initialize a first user profile for a first user within a first instance of the user portal; generate a prompt to selectively link the first user profile to another user profile in a population of user profiles; and transmit the prompt to the first user via the first instance of the user portal. Then, in response to receiving selection of a second user profile, in the population of user profiles, associated with a second user, the computer system can: generate a prompt to confirm linking of the first user profile with the second user profile; transmit the prompt to the second user via a second instance of the user portal affiliated with the second user; and, in response to receiving confirmation from the second user, link the first user profile with the second user profile.

Additionally or alternatively, in another example, the computer system can: implement the steps above to initialize a first user profile for a first user within a first instance of the user portal; generate a prompt to initialize a second user profile for a second user affiliated with the first user; and transmit the prompt to the first user via a first instance of the user portal.

### 4.1 Configurations

In one implementation, the computer system can automatically select and/or suggest a particular configuration—defining a set of rules for expense sharing, transaction visibility, etc.—for a group of users forming a cohort (e.g., including two or more users). For example, the computer system can define a set of standard configurations, such as including: a first standard configuration—defining a first set of rules—for spouses; a second standard configuration—defining a second set of rules—for a parent and their child or children; a third standard configuration—defining a third set of rules—for an adult child and their elderly parent(s); a fourth standard configuration—defining a fourth set of rules—for roommates; etc.

Additionally or alternatively, in another implementation, the computer system can enable the user or users to further customize these configurations based on personal preferences for privacy, expense sharing, spending limits, etc. For example, the computer system can: initially suggest a standard configuration—defining a first set of rules—for a parent and their child; receive a set of modifications to the standard configuration from the parent; update the first set of rules based on the set of modifications to generate a second set of rules; and transmit the second set of rules for review to both the parent and the child for review.

Furthermore, in one variation, the computer system can “share” customized configurations—generated for one user or a pair of users—with other users interested in implementing similar configurations. For example, the computer system can: generate a first configuration for a first parent and a first child, such as based on a standard configuration and/or customizations implemented by the parent; receive a request to share the first configuration with a second parent from the first parent; and transmit the first configuration—defining a set of rules—to the second parent for implementing with their child. Therefore, the second parent may select the first configuration, and the computer system can implement this first configuration for the second parent and their child accordingly.

Additionally, the computer system can implement various budgeting tools and/or interface with external budgeting tools—configured to promote following of a budget by one or more users—as selected by the user or group of users during or following onboarding.

### 5. Sequestration of Funds

Generally, the computer system can automatically sequester a financial amount (e.g., a dollar amount, a percentage of funds in an account) assigned to a particular expense during a payment period. For example, the computer system can sequester a financial amount corresponding to a committed expense (e.g., a recurring expense) and/or sequester a financial amount corresponding to a target savings goal defined for the user.

For example, the computer system can: prompt the user to select a primary account (e.g., an existing checking account) from which the user may deposit funds, withdraw funds, and/or initiate payments to other accounts or payees; access a fixed financial amount of a recurring expense paid by the user from the primary account according to a fixed schedule (e.g., weekly, monthly, quarterly, seasonally) or Situation; define a first sequestration rule for the user defining a sequestered financial amount corresponding to the fixed financial amount for a time window defined based on the fixed schedule. Then, at a start of the time window, the computer system can: automatically allocate the sequestered financial amount for paying the recurring expense during the time window based on the first sequestration rule; and restrict the user from accessing the sequestered financial amount during the time window. Finally, the computer system can automatically release the sequestered financial amount to a payee associated with the recurring expense according to the fixed schedule during the time window. Therefore, the computer system can leverage funds in the sequestered account to automatically execute payments for committed expenses (e.g., bills, tax payments) to corresponding recipients.

In one implementation, the computer system can restrict access to sequestered funds until all bills owed for a particular time window are paid by the user. For example, the computer system can: access a set of committed expenses (e.g., rent, subscription services, membership fees, escrow for property taxes and/or property insurance) that must be paid by the user during a time window (e.g., one week, one month); calculate a financial amount required to cover the set of committed expenses during the time window; and automatically sequester this financial amount for the user during the time window, such as by transferring the financial amount into a sequestered account. In this example, in response to the user completing payment associated with each committed expense, in the set of committed expenses, the computer system can automatically release any remaining funds—from the financial amount sequestered (e.g., in the sequestered account)—to the user for any purpose, such as by transferring these remaining funds from the sequestered account into the user's primary account or a goal-defined savings account (e.g., emergency fund, saving for a trip, educational expenses). alternatively, the computer system can retain remaining funds within the sequestered account for future payments, thereby reducing a financial amount required by the user during a subsequent payment period (eg seasonal).

Additionally or alternatively, in another implementation, the computer system can automatically sequester funds for each committed expense, in a set of committed expenses, over time windows of varying duration. For example, for a first committed expense corresponding to payment of the user's rent, the computer system can automatically sequester a corresponding financial amount for a time window of 45 days in order to ensure the user's primary account contains sufficient funds for payment of rent, which may be a high priority expense for the user. Then, for a second committed expense corresponding to payment for a streaming service, the computer system can automatically sequester a corresponding financial amount for a time window of 7 days in order to ensure the user's primary account contains sufficient funds for payment for the streaming service, which may be a relatively lower priority expense for the user.

In another example, the computer system can: automatically sequester a first financial amount—falling below a threshold amount (e.g., defined by the user and/or automatically by the computer system)—associated with a first committed expense for a time window of a first duration; and automatically sequester a second financial amount—exceeding the threshold amount—associated with a second committed expense for a time window of a second duration exceeding the first duration, thereby ensuring funds are available for greater expenses and/or providing the user increased time to plan for these expenses accordingly. Therefore, the computer system can modify a time window for sequestration of funds for a particular expense based on a priority level of the particular expense and/or a financial amount associated with the particular expense.

In one implementation, the computer system can automatically sequester a financial amount—assigned to a set of expenses during the payment period—at a particular time (e.g., a pay day) associated with receipt of the user's income in the user's primary or spending account. For example, the computer system can: prompt the user to provide a pay schedule defining timing and/or frequency of income payments for the user; and/or automatically interpret the pay schedule of the user based on financial documents provided by the user during onboarding. By withdrawing funds for sequestration approximately concurrently and/or after receipt of income for the user, the computer system can ensure availability of funds in the user's account for sequestration.

### 6. Target Savings

Generally, the computer system can set a target savings amount for the user—such as for transferring from a primary account (e.g., a checking account) into one or more savings account affiliated with the user—and selectively promote saving of the target savings amount by the user during a spending period (e.g., one month, one quarter, one year).

In one implementation, the computer system can: sequester a target savings amount for the user at a start of a spending period; predict and/or detect a deficit in the user's initiated and/or predicted expenses during the spending period; withdraw from the target savings amount to account for the predicted deficit; and assign a penalty to the user for withdrawing from savings and/or failing to meet the target savings amount for the spending period. For example, the computer system can assign a penalty corresponding to: repayment of the target savings amount with interest during a subsequent payment period; depositing of a particular amount into a retirement fund affiliated with the user; increasing the target savings amount for one or more subsequent saving periods; reducing a financial amount (e.g., a recurring financial amount, a one-time financial amount) provided by a supporter user to the subordinate user); etc.

In one example, the computer system can: via the user portal, prompt the user to set a target savings amount for a time window (e.g., a month, a quarter, a semester, a year); access an average expected income for the user during a preceding time window of a duration equivalent to a duration of the time window, such as an average income defined by the user or derived from a set of financial documents specifying user income during the preceding time window; and access a set of known and/or predicted expenses from the user's primary account (e.g., a checking account) during the time window. Then, during the time window, the computer system can: automatically allocate the target savings amount for depositing in a savings account associated with the user and/or automatically transfer this target savings amount into the savings account, such as at a start of the time window; automatically initiate payment of bills and/or other known expenses (e.g., recurring expenses) from the primary account; track a timeseries of purchases initiated by the user from the primary account during the time window; and, based on the timeseries of expenses, the average expected income, and the set of known and/or predicted expenses, predict a likelihood that the primary account will include sufficient funds for payment of all expected and/or predicted expenses during a remainder of the time window.

Then, in response to predicting a deficit for the primary account at an end of the time window, the computer system can automatically initiate a transfer of funds from the savings account into the primary account to offset the predicted deficit and enable payment of all known and/or expected expenses during the time window. Furthermore, the computer system can set a value (e.g., a percentage, a fixed amount) of interest for repayment of these funds into the savings account that must be paid by the user—such as from the primary account (e.g., checking account) into the savings account—during future time windows as a penalty for not meeting the target savings amount for this time window and/or withdrawing from the savings account. Therefore, the computer system can: “penalize” the user for deviating from their savings goals without requiring payment of penalties to an external party; and enable the user to repay this amount with interest in the future and, therefore, replenish the savings account, thereby promoting reduced spending and increased saving by the user. In another example, in response to the user deviating from their savings goal and/or in response to insufficient funds in the sequestered account for payment of the user's expenses, the computer system can: access a “penalty” account generated for the user, such as generated by the computer system or a third-party banking system; calculate a penalty amount for the user based on a deficit amount predicted and/or detected for the user; and prompt the user to deposit the penalty amount into the penalty account. Alternatively, the computer system can automatically transfer the penalty amount into the penalty account accordingly.

### 6.1 Setting Target Savings

In one implementation, the computer system can automatically suggest a target savings amount to the user based on: characteristics of the user (e.g., the user's income, age, spending habits, a geographic location); a flat recommended percentage of the user's income (e.g., five percent, ten percent, twenty percent); a set of goals provided by the user, such as saving for a particular expense (e.g., a house, a vehicle, furniture, medical expenses); and/or estimated tax liabilities of the user. In this implementation, the computer system can suggest and/or set a target savings amount for each savings account—such as including a primary savings account, an “emergency” fund, a “car repair” fund, an “education” fund, etc.—associated with the user.

For example, the computer system can: access an expected income defined for the user during a first time period; based on the expected income, estimate a financial amount of tax liabilities for the first user during a global time period including the first time period; access a savings goal—such as specifying a percentage of income and/or a future expense the user is saving toward—defined by the first user for the global time period; and, based on the financial amount of tax liabilities and the savings goal defined by the first user for the global time period, estimate a target savings amount for the first time period.

Additionally or alternatively, in another implementation, the computer system can: generate a prompt to set a savings goal; transmit the prompt to the user (and/or a supporter user affiliated with the user); and, in response to receiving confirmation of a target saving amount for the user, store this target saving amount in the user profile affiliated with the user.

### 7. Multiple Users: Subordinate User & Supporter User

In one implementation, the computer system can promote joint management (or team management) of a financial account of a subordinate user's finances by both the subordinate user(s) and supporter(s) user exhibiting authority over the subordinate user.

In particular, in this implementation, the computer system can: track expenses and/or income of the subordinate user over time; selectively serve electronic notifications—indicating budget deficits, budget surpluses, changes in the subordinate user's spending/earning patterns, etc.—to both a subordinate user (e.g., a child) of a first authority level and a supporter user (e.g., a parent) of a second authority level exceeding the first authority level.

In this implementation, the computer system can initially prompt the supporter user—and/or the subordinate user—to confirm a set of privacy settings for implementation during management of the subordinate user's finances. For example, the computer system can: access a record of financial statements affiliated with the first user; automatically generate a recommendation for a set of privacy settings—including settings for authority, electronic notifications, transaction visibility, etc.—based on the record; transmit the recommendation to the supporter user for review; and, in response to receiving confirmation of the recommendation, store the set of privacy settings in a user profile associated with the first user. The computer system can also share this set of privacy settings with the subordinate user for review in order to encourage transparency and/or trust between the supporter user and the subordinate user. For example, the computer system can suggest a set of privacy settings related to: whether and/or when the supporter user may view transactions—of various types (e.g., discretionary, nondiscretionary)—initiated by the subordinate user (and/or vice versa); when the supporter user is notified regarding financial events (e.g., transactions, income, a surplus, a deficit) of the subordinate user (and/or vice versa); whether the supporter user and/or subordinate user may modify privacy settings; whether privacy settings can be automatically modified by the computer system (e.g., to escalate and/or deescalate privacy or authority), such as responsive to financial events; etc. Then, during a spending period, the computer system can implement the set of privacy settings to selectively present financial information of the subordinate user to the supporter user.

In one example, the computer system can: interface with a first group of users including a parent as the supporter user and one or more of their children as the subordinate user; interface with a second group of users including a parent as a first supporter user, a virtual agent (e.g., an intelligent agent) as a second supporter user, and one or more of the parent's children as the subordinate user(s); interface with a third group of users including an adult child as the supporter user and one or more of their parents as the subordinate user; interface with a fourth group of users including a third-party financial advisor as the supporter user and an individual user as the subordinate user; etc.

Generally, Blocks of the method S100 are described below as executed by the computer system to enable joint management of a financial account by a single subordinate user and a single supporter user exhibiting authority over the subordinate user. However, Blocks of the method S100 can be executed by the computer system to enable joint or team management of one or more financial accounts by one or more subordinate users and one or more supporter users exhibiting authority over the subordinate users. Additionally, Blocks of the method S100 can be executed by the computer system to enable: management of a first financial account between a first user functioning as a subordinate user and a second user functioning as a supporter user; management of a second financial account between a third user functioning as a subordinate user and the first user functioning as a supporter user; and management of a third financial account between the first user and a fourth user exhibiting equal authority over the third financial account.

### 7.1 Savings & Sequestered Amounts

During a setup period, the computer system can prompt the subordinate user—and/or the supporter user on behalf of the subordinate user—to provide: access to one or more financial accounts affiliated with the subordinate user, such as including a primary payment account (hereinafter “primary account’) (e.g., a checking account), a savings account; access to bill pay for a set of committed expenses defined for the subordinate user, such as including a rent payment, a car payment, a tuition payment, subscription services, etc.; and/or a set of historical financial documents specifying user income and/or spending during a preceding time window. Furthermore, the computer system can prompt the user to set a target savings amount for each spending period (e.g., a month, a quarter, a semester, a year).

Then, at a start of a first spending period, the computer system can: deposit the target savings amount into the subordinate user's savings account; sequester a financial amount—such as in a sequestered account accessible by the supporter user—required to cover the set of committed expenses; and track timeseries expenses initiated by the subordinate user during the first spending period.

As described further below, based on these timeseries expenses, the computer system can selectively expose income streams and/or expenses—such as including discretionary and/or nondiscretionary expenses—initiated by the subordinate user to the supporter user and/or selectively prompt the supporter user to provide funds to the subordinate user. For example, in response to the subordinate user overspending—and thus experiencing a spending deficit—the computer system can: present minimum information necessary to the supporter user in response to the spending deficit corresponding to a nondiscretionary expense (e.g., tuition, rent) and/or in response to the spending deficit falling below a threshold; and present more information to the supporter user in response to the spending deficit corresponding to a discretionary expense (e.g., eating out, subscription services) and/or in response to the spending deficit exceeding the threshold.

Furthermore, the computer system can selectively sequester a financial amount—in a sequestered account accessible by the supporter user and/or subordinate user—from financial accounts of both the subordinate user and the supporter user. The computer system can, therefore, enable the supporter user to provide funds for the subordinate user's sequestered account. However, the computer system can automatically vary a financial amount provided by the supporter user—to the sequestered account—based on timeseries expenses initiated by the subordinate user, such as based on whether the subordinate user meets target savings and/or budgeting goals.

In one variation, the computer system can enable rewarding of the subordinate user for successfully sequestering funds—such as sufficient to cover a set of committed expenses—across one or more spending periods. For example, in response to the subordinate user transferring sufficient funds into the sequestered account to cover all committed expenses across a series of payment periods, the computer system can: generate a notification indicating successful sequestration of funds and payment of committed expenses by the subordinate user; append the notification with a suggestion to transfer a financial reward into the sequestered account and/or the subordinate user's primary account to encourage continued funding of the sequestered account; and transmit the notification to the supporter user. In another example, the computer system can automatically: calculate an amount of a financial reward for the subordinate user based on an amount of funds sequestered in the sequestered account (e.g., across the series of payment periods); and automatically deposit a financial reward (e.g., from an account of the supporter user) into the sequestered account and/or the subordinate user's primary account, such as based on settings selected by the supporter user during onboarding.

### 7.2 Deficit Detected

Generally, the computer system can detect a spending deficit—such as characterized by insufficient funds in the primary account for payment of committed expenses—for the subordinate user during a spending window.

In particular, in one implementation, the computer system can: access an expected income defined for the subordinate user during a spending period; access a set of committed expenses predefined for the spending period for the subordinate user; and access one or more financial statements—detailing a first set of expenses initiated by the subordinate user during the spending period—for the primary account associated with the subordinate user. Then, based on the expected income, the set of committed expenses, the first set of expenses, and a first financial amount remaining in the primary account, the computer system can detect a spending deficit of a first deficit amount during the first time period.

Then, in response to detecting the spending deficit, the computer system can selectively notify the subordinate user and the supporter user of the spending deficit. In particular, the computer system can: generate an electronic notification describing the spending deficit and one or more expenses, in the first set of expenses, contributing toward the spending deficit; transmit the electronic notification to the supporter user via a first instance of the user portal affiliated with the supporter user; and transmit the electronic notification to the subordinate user via a second instance of the user portal affiliated with the subordinate user.

### 7.2.1 Cause of Deficit & Transaction Visibility

In one implementation, in response to detection and/or prediction of a budget deficit, the computer system can predict a first subset of expenses, in the set of expenses initiated during the spending period, corresponding to (e.g., contributing toward) the budget deficit. The computer system can then selectively surface this first subset of expenses to the subordinate user and the supporter user in order to provide further context regarding the budget deficit while maintaining a degree of privacy for the subordinate user by withholding visibility of a second subset of expenses, in the set of expenses, unrelated to the budget deficit.

For example, the computer system can: access a first financial statement—defining a first set of expenses initiated by the first user during a first time period—of the subordinate user; extract a first set of language signals from the first financial statement; and, based on the first set of language signals, identify a first set of discretionary expenses, in the first set of expenses, identify a first set of non-discretionary expenses in the first set of expenses. Then, in response to detecting and/or predicting a first budget deficit, the computer system can: identify one or more discretionary expenses, in the first set of discretionary expenses, contributing toward the first budget deficit based on a first subset of language signals, in the first set of language signals, corresponding to the first set of discretionary expenses; generate an electronic notification describing the first budget deficit and the one or more discretionary expenses contributing toward the first budget deficit; transmit the first electronic notification to the subordinate user; and transmit the first electronic notification to the supporter user.

Therefore, the computer system can provide both users with a predicted cause—such as a set of discretionary expenses—of the budget deficit, thereby providing transparency to the supporter user while promoting improvement in spending related to the predicted cause by the subordinate user.

### 7.2.2 Action Required & Notification Settings

In response to detecting a budget deficit, the computer system can selectively attempt to recover funds for mitigating the budget deficit.

In one implementation, in response to the budget deficit falling within a first deficit range, the computer system can: automatically notify both the supporter user and the subordinate user of the budget deficit; and request supplementation of funds to the subordinate user from the supporter user.

In particular, in this implementation, in response to the budget deficit falling within the first deficit range, the computer system can: generate a request to transfer funds from a first financial account, associated with the supporter user, into a second financial account associated with the subordinate user; generate a first electronic notification describing the budget deficit and a subset of expenses associated with the budget deficit; transmit the first electronic notification to the subordinate user (e.g., via a first instance of the user portal); generate a second electronic notification describing the budget deficit and the subset of expenses associated with the budget deficit and including the request to transfer funds; and transmit the second electronic notification to the supporter user (e.g., via a second instance of the user portal).

Additionally or alternatively, in another implementation, the computer system can initially notify the subordinate user of adverse events (e.g., a deficit); and selectively notify the supporter user of adverse events at a later time based on the subordinate user's response to the initial notification. In one example, in response to the budget deficit falling within a second deficit range less than the first deficit range, the computer system can: generate a prompt to transfer a financial amount—corresponding to the budget deficit—from a third financial account (e.g., a savings account), associated with the subordinate user, into the second financial account (e.g., checking account); and transmit the prompt to the subordinate user. Therefore, the computer system can enable the subordinate user to mitigate the budget deficit before notifying the supporter user of the budget deficit. In this example, in response to the subordinate user moving funds from the third financial account (e.g., the savings account) into the second financial account (e.g., checking account), the computer system can selectively assign a penalty—such as an interest percentage for repayment of the savings account and/or a fixed amount for payment into a retirement account—to the financial amount withdrawn from the third financial account (as described above).

However, in response to the third financial account of the subordinate user containing insufficient funds to cover the budget deficit, the computer system can similarly notify the supporter user and request transfer of funds to the subordinate user. In particular, the computer system can access a total amount of funds present in the third financial account and, in response to the total amount of funds falling below the financial amount of the budget deficit: generate a request to transfer funds from the first financial account, associated with the supporter user, into the second financial account associated with the subordinate user; generate an electronic notification describing the budget deficit and including the request; and transmit the electronic notification to the supporter user.

Additionally or alternatively, in another implementation, in response to the budget deficit falling within a third deficit range exceeding the first deficit range, the computer system can automatically surface all relevant financial information to the supporter user. In particular, in this implementation, in response to the budget deficit falling within the third deficit range, the computer system can: generate an electronic notification describing the budget deficit and each discretionary expense and/or nondiscretionary expense initiated by the user during the spending period; generate a request to transfer funds from the first financial account affiliated with the supporter user into the second financial account affiliated with subordinate user; and transmit the electronic notification—including the request—to the supporter user for review.

Therefore, the computer system can selectively escalate an amount of information conveyed to the supporter user based on a magnitude of the budget deficit and/or a cause—such as including one or more discretionary and/or nondiscretionary expenses—of the budget deficit. Additionally, the computer system can selectively escalate/increase the authority of the supporter user over the supported user's account(s) based on the magnitude of the budget deficit and/or a cause of the budget deficit.

### 7.2.3 Deficit Predicted: User Guidance for Correcting Deficit

In one implementation, in response to predicting a spending deficit for the user during the spending window, the computer system can provide guidance to the user for limiting spending during a remainder of the spending period in order to minimize and/or avoid the predicted spending deficit.

In particular, in this implementation, the computer system can: implement the methods and techniques described above to predict a spending deficit for the user during the spending period; generate a notification describing the spending deficit and a set of expenses—initiated by the user during the spending period—contributing toward the predicted spending deficit; and transmit the notification to the user via the user portal.

Additionally, in this implementation, the computer system can append the notification with a prompt to implement a particular set of saving techniques to reduce spending over a remainder of the spending period. For example, the computer system can append the notification with a prompt to eliminate spending in a discretionary expense category—such as including restaurants, food delivery, online retail shopping, etc.—and/or reduce spending in the expense category by a particular amount. Therefore, the computer system can promote improved spending behavior by the user in order to avoid the predicted spending deficit prior to notifying a supporter user of the predicted deficit.

In particular, in one example, the computer system can: predict a spending deficit for the user during the spending period based on a financial statement detailing the user's expenses during the spending period; and, based on language signals extracted from the financial statement, identify a set of non-discretionary expenses included in the financial statement and identify a set of discretionary expenses included in the financial statement. The computer system can then: identify a subset of discretionary expenses, in the set of discretionary expenses, contributing toward the spending deficit; and, based on language signals extracted from the subset of discretionary expenses listed in the financial statement, identify a spending category associated with one or more expenses in the subset of discretionary expenses. The computer system can then generate a notification: describing the predicted spending deficit and the subset of discretionary expenses; including a prompt to eliminate spending in the spending category for a remainder of the time window; including a warning that the supporter user will be notified of the predicted deficit during a warning period prior to expiration of the spending period (e.g., by one day, one week, two weeks) if the user maintains the predicted spending deficit and/or does not follow guidelines to eliminate spending in the spending category. The computer system then transmits this notification to the subordinate user via the user portal.

Therefore, in this example, the computer system alerts the user to the predicted spending deficit and provides tailored guidance for avoiding the predicted spending deficit. Furthermore, the computer system warns the user that the supporter user (e.g., the user's parent or other authority figure) will be notified of the predicted deficit if the user does not self-correct their spending for the spending period prior to the warning period. In response to successful execution of the spending suggestion by the subordinate user prior to the warning period, the computer system can withhold transmittal of an electronic notification—describing the predicted spending deficit—to the supporter user. The computer system, therefore, empowers the user to correct their spending habits—without intervention from the supporter user—while selectively notifying the supporter user as needed if the user fails to avoid the predicted spending deficit.

Furthermore, in one variation, the computer system can automatically suggest alternate spending to the subordinate user in response to prediction and/or detection of the deficit. For example, in response to predicting a deficit for the subordinate user, the computer system can: identify a set of discretionary expenses—including a subscription-based entertainment service and/or restaurant delivery service—initiated by the subordinate user and contributing toward the deficit; identify an ad-supported entertainment service; identify a grocery store within a threshold distance of the subordinate user's home in replacement of the restaurant delivery service; generate a prompt to consider watching the ad-supported entertainment service—in replacement of the subscription-based entertainment service—and/or visiting the grocery store in replacement of ordering food via the restaurant delivery service; and transmit the prompt to the subordinate user.

### 7.3 Surplus Predicted

Generally, the computer system can predict and/or detect a spending surplus—such as characterized by an excess of funds in the primary account for payment of committed expenses and/or a target savings amount—for the subordinate user during a spending window.

In particular, in one implementation, the computer system can: access an expected income defined for the subordinate user during a spending period; access a set of committed expenses predefined for the spending period for the subordinate user; and access one or more financial statements—detailing a first set of expenses initiated by the subordinate user during the spending period—for the primary account associated with the subordinate user. Then, based on the expected income, the set of committed expenses, the first set of expenses, and a first financial amount remaining in the primary account, the computer system can detect a spending surplus of a first surplus amount during the first time period.

Then, in response to detecting the spending surplus, the computer system can selectively notify the subordinate user and the supporter user of the spending surplus. In particular, the computer system can: generate an electronic notification describing the spending surplus and excluding description of the first set of expenses; transmit the electronic notification to the supporter user via a first instance of the user portal affiliated with the supporter user; and transmit the electronic notification to the subordinate user via a second instance of the user portal affiliated with the subordinate user. By notifying both users of the spending surplus, the computer system can encourage the subordinate user to maintain positive spending behaviors by providing positive feedback to both the subordinate user and the supporter user.

### 7.4 Dynamic Privacy Settings

In one implementation, the computer system can dynamically update privacy and/or notification settings between the subordinate user(s) and the supporter user(s) based on behaviors of the subordinate user over time.

For example, during a first time period, the computer system can implement a first set of privacy settings corresponding to a first privacy level configured to minimize a quantity of notifications sent to the supporter user and promote establishment of trust between the subordinate user and the supporter user. Then, during a second time period succeeding the first time period, in response to the subordinate user experiencing a series of spending deficits within a particular time window, the computer system can automatically implement a second set of privacy settings—in replacement of the first set of privacy settings—corresponding to a second privacy level lower than the first privacy level and configured to: selectively increase the quantity of notifications sent to the supporter user; and/or increase visibility of transactions—initiated by the subordinate user—to the supporter user. Additionally or alternatively, in this example, the computer system can: generate a prompt to review the second set of privacy settings and to authorize or reject the second set of privacy settings in replacement of the first set of privacy settings; transmit the prompt to the supporter user; and, in response to receiving authorization of the second set of privacy settings, implement the second set of privacy settings. The computer system can also notify the subordinate user of implementation of the second set of privacy settings by the supporter user.

Therefore, the computer system can update notification frequency and/or transaction visibility responsive to successes and/or failures of the subordinate user to meet budgeting goals and/or remit payment for all initiated expenses.

### 7.5 Tracking Progress & Scoring the Subordinate User

In one implementation, the computer system can: track user progress—of the subordinate user—in following a budget and/or meeting financial goals over time; selectively surface user progress and/or regression to the supporter user; and/or selectively update privacy settings—such as related to visibility of expenses (e.g., discretionary and/or nondiscretionary), notification frequency, etc.—between the subordinate user and the supporter user accordingly.

For example, the computer system can: implement methods and techniques described above to predict and/or detect a budget surplus for the subordinate user during a first spending period; and characterize user progress—such as represented by a numerical or qualitative score—of the subordinate user maintaining their budget based on the budget surplus. Then, in response to user progress exceeding a threshold progress, the computer system can: access a first set of privacy settings defining visibility of finances of the subordinate user by the supporter user, the first set of privacy settings implemented during the first spending period; select a second set of privacy settings defining visibility of finances of the subordinate user by the supporter user for a second time period, the second set of privacy settings configured to reduce visibility of finances of the subordinate user by the supporter user; generate a prompt to authorize replacement of the first set of privacy settings with the second set of privacy settings for implementation during the second time period; and transmit the prompt to the supporter user for review and/or authorization. Furthermore, the computer system can: generate an electronic notification describing the budget surplus and user progress; and transmit this electronic notification to both the subordinate user and the supporter user.

Therefore, by surfacing progress of the subordinate user to both the subordinate user and the supporter user—and/or selectively suggesting modified privacy settings between these users—the computer system can promote implementation of positive (or desired) spending behaviors by the subordinate user by providing positive feedback and enabling increased privacy, while enabling the supporter user to view the subordinate user's progress and adjust management techniques accordingly.

In one variation, the computer system can derive a score for the subordinate user representative of the subordinate user's behaviors within a particular time window. In one example, the computer system can derive a composite score the for the subordinate user based on: a literacy score representing the subordinate user's financial literacy; a trust score representing the subordinate user's trustworthiness; and/or an effort score representing an amount of effort dedicated by the subordinate user to meeting budget goals and/or remitting payment for all initiated expenses within a corresponding spending period.

In particular, in this example, the computer system can: calculate the literacy score based on a quantity and/or magnitude of budget deficits experienced by the subordinate user, an average savings amount saved by the subordinate user each spending period, an average retirement amount invested in a retirement account by the subordinate user each spending period, a percentage of committed expenses paid and/or unpaid by the subordinate user each spending period, etc.; calculate the trust score based on types of expenses—including discretionary and/or nondiscretionary expenses—initiated by the subordinate user during a spending period; calculate the effort score based on user progress over time and/or a magnitude of budget deficits and/or budget surpluses; and calculate the composite score based on a combination of the literacy score, the trust score, and the effort score. Then, the computer system can share this composite score—including a breakdown of the literacy, trust, and effort scores—with both the subordinate user and the supporter user for review. Furthermore, based on the composite score, the computer system can selectively suggest updated privacy settings—defining settings for notification frequency and/or transaction visibility to the supporter user—between the subordinate user and the supporter user.

### 8. Electronic Notifications

Generally, the computer system can selectively generate and serve notifications—indicating detected and/or predicted deficits and surpluses—to one or more users associated with an account, such as including the subordinate user, one or more supporter users, etc. As described above, the computer system can selectively generate these electronic notifications—including tailored content specific to a particular recipient (e.g., subordinate user, supporter user)—based on: whether a deficit is detected and/or predicted; whether a surplus is detected and/or predicted; a magnitude (e.g., amount) of a deficit or surplus; an expense type—such as including discretionary, nondiscretionary, a particular category (e.g., education, food, social, online shopping), etc.—of one or more expenses associated with a deficit or surplus, etc.

For example, in response to detecting a first deficit—of a first magnitude falling below a threshold magnitude—associated with a first set of expenses initiated by a subordinate user, the computer system can: generate a first notification indicating detection of the first deficit; transmit the first notification to the supporter user; generate a second notification indicating detection of the first deficit and describing the first set of expenses; and transmit the second notification to the subordinate user. Then, in response to detecting a second deficit—of a second magnitude exceeding the threshold magnitude—associated with a second set of expenses initiated by the subordinate user, the computer system can: generate a third notification indicating detection of the deficit and describing the first set of expenses; and transmit the third to both the supporter user and the subordinate user. In this example, the computer system can automatically increase density of information provided to the supporter user based on the magnitude of the deficit.

In another example, in response to detecting a surplus exceeding a threshold surplus, the computer system can: generate a notification indicating detection of the surplus; and transmit the notification to the supporter user and the subordinate user. Therefore, in this example, the computer system can leverage detection of the surplus—exceeding the threshold surplus—to increase the supporter user's trust in the subordinate user and provide positive reinforcement to the subordinate user.

The computer system can also selectively generate and serve electronic notifications—indicating detected and/or predicted deficits and surpluses—to one or more advisor users associated with the subordinate user. The computer system can, therefore, enable the subordinate user to receive guidance from an independent advisor (e.g., a financial advisor, a virtual assistant agent).

In one implementation, the computer system can selectively generate and serve electronic notifications to one or more supporter users associated with an account, such as including a first supporter user, a second supporter user, etc. The computer system can selectively generate these electronic notifications—including tailored content specific to a particular supporter user in a set of supporter users associated with one or more subordinate users—based on: whether a deficit is detected and/or predicted; whether a surplus is detected and/or predicted; a magnitude of a deficit or surplus; an expense type—such as including discretionary, nondiscretionary, a particular category (e.g., education, food, social, online shopping), etc.—of one or more expenses associated with a deficit or surplus; a particular account associated with a deficit or surplus; etc. The computer system can, therefore, identify a particular supporter user, in the supporter users, associated with a particular event (e.g., deficit, surplus) and notify this supporter user accordingly.

### 9. Variation: Equal Users

In another implementation, the computer system can promote joint management of one or more financial accounts affiliated with users of equal authority, such as including spouses, partners, roommates, or divorced parents managing their children's finances.

In this implementation, the computer system can similarly prompt each user, in a user cohort, to confirm a set of privacy settings for implementation during management of the user cohort's finances. In one example, the computer system can implement a set of privacy settings defining: a first privacy level—corresponding to full visibility—assigned to expenses in a first spending category relevant to each user in the user cohort, such as including a rent or mortgage payment; a second privacy level—corresponding to partial visibility—assigned to expenses in a second spending category including discretionary and/or nondiscretionary spending; and/or a third privacy level—corresponding to no visibility—assigned to expenses in a third spending category including only discretionary spending. Therefore, the computer system can enable equal users in the user cohort to view a subset of expenses initiated by other users in the user cohort while maintaining a degree of privacy for users by withholding visibility of remaining expenses.

In this implementation, the computer system can: receive a first set of financial documents affiliated with a first user in a cohort, such as including a first set of recent pay stubs, a first set of tax documents (e.g., a form W-2, a form 1099), a first set of bank statements, a first set of monthly bills paid by the first user, etc.; receive a second set of financial documents affiliated with a second user in the cohort, such as including a second set of recent pay stubs, a second set of tax documents, a second set of bank statements, a second set of monthly bills paid by the second user, etc.; receive selections—from both the first and second users—of shared expenses and/or nonshared expenses between the first and second users; automatically generate a sequestered account for storing funds associated with payment of shared expenses; automatically suggest a set of privacy settings for notification content and/or frequency, transaction visibility, etc. during management of the cohort's finances; and define a set of rules—such as automatically suggested by the computer system and/or manually selected by users in the cohort—for funding the sequestered account.

For example, the computer system can: generate a sequestered account for a cohort including a first spouse and a second spouse; receive a set of financial documents provided by the first spouse and the second spouse; based on the set of financial documents, suggest a first financial amount—configured to pay for a first portion of a mortgage payment and a car payment—for the first spouse to deposit in the sequestered account each spending period; and, based on the set of financial documents, suggest a second financial amount—configured to pay for a second portion of the mortgage payment and the car payment—for the second spouse to deposit in the sequestered account each spending period. In particular, in this example, the computer system can suggest the second financial amount—less than first financial amount—based on historical portions of the mortgage payment and the car payment paid by each spouse and/or in response to the second spouse earning a lower income than the first spouse. The computer system can then: access a first primary spending account—affiliated with the first spouse—for funding the sequestered account; and access a second primary spending account—affiliated with the second spouse—for funding the sequestered account. The computer system can then: fund the sequestered account accordingly; and automatically release funds from the sequestered account for payment of a set of committed expenses defined for the cohort (e.g., as described above).

Then, during a spending period, the computer system can selectively generate and transmit electronic notifications to each spouse regarding funding of the sequestered account. For example, during the spending period, in response to the first spouse depositing the first financial amount into the sequestered account and the second spouse withholding depositing of the second financial amount into the sequestered account, the computer system can: generate a first electronic notification indicating withholding of the second financial amount from the sequestered account by the second spouse; append the first electronic notification with a prompt to deposit the second financial amount into the sequestered account by a target deadline; and transmit the first electronic notification to the second spouse. Then, in response to the second spouse withholding depositing of the second financial amount into the sequestered account at the target deadline, the computer system can: generate a second electronic notification indicating withholding of the second financial amount from the sequestered account by the second spouse; append the second electronic notification with a request to transfer the second financial amount from the first primary spending account of the first spouse into the sequestered account; and transmit the second electronic notification to the first spouse.

In this example, in response to failure to deposit the second financial amount into the sequestered account by the second spouse, the computer system can automatically apply a penalty to the second spouse for one or more spending periods, such as requiring the second spouse to deposit additional funds into a retirement account and/or requiring the second spouse to repay the second financial amount to the first primary spending account of the first spouse with interest. Therefore, in this example, the computer system can enable the spouses to manage their shared expenses in the sequestered account—while ensuring presence of sufficient funds in the sequestered account for payment of shared expenses—and maintain a degree of privacy by withholding information regarding each individual spouse's primary spending account.

### 10. Variation: Tax Management

In one variation, the computer system can enable management and/or tracking of tax liabilities for a single user and/or for multiple users filing taxes jointly. In particular, in this variation, the computer system can: access a target tax liability (or refund) defined for a user or user cohort (e.g., spouses or executives of a taxable legal entity) for a tax period; track income(s) of each user throughout the tax period; and automatically modify withholding amounts throughout the tax period in order to achieve the target tax liability at an expiration of the tax period. Furthermore, in this variation, the computer system can leverage historical tax and/or income data of each user to automatically set or suggest an initial withholding amount. For example, the computer system can leverage income data, tax payment data, and/or withholding data from payroll data sources, financial data vendors, financial system records, taxpayer records, taxpayer inputs, etc. to set or suggest withholding amounts and/or to execute tax deduction calculations.

Therefore, rather than perform these evaluations annually and/or infrequently over a taxable year, the computer system can automatically re-calculate income, deductions, tax liability, and other related information—which may exhibit variability throughout the taxable year—for each user continuously and/or semi-continuously, such as responsive to each taxable transaction and/or each deductible transaction or based on predictions. The computer system thus enables each user to actively track insights related to income, deductions, tax liability, etc. throughout the taxable year and, therefore, reduces frequency of error in calculations and/or surprise to these users.

For example, for spouses filing taxes jointly, the computer system can: access a first set of income documents (e.g., pay stubs) generated for a first spouse during a preceding time period; access a first set of tax documents (e.g., W9, W2) generated for the first spouse during the preceding time period; estimate a first average income of the first spouse based on the first set of income documents and the first set of tax documents; and repeat this process for the second spouse to estimate a second average income of the second spouse based on a second set of income documents and a second set of tax documents generated for the second spouse. The computer system can then prompt the first and second spouse to define a target tax liability for a tax period, and, based on the target tax liability approved by both spouses: automatically set and/or suggest a first withholding and/or sequestration amount for the first spouse at an initial time during the tax period; and automatically set and/or suggest a second withholding and/or sequestration amount for the second spouse at the initial time during the tax period.

Then, during the tax period, the computer system can continue to access income documents of both spouses to track any changes income between the first and second spouses. In particular, in this example, in response to detecting a change in average income of the first spouse from the first average income to a third average income exceeding the first average income, the computer system can automatically adjust the first withholding amount and/or the second withholding amount in order to achieve the target tax liability with the third average income of the first spouse and the second average income of the second spouse.

Additionally, in this example, the computer system can automatically sequester funds throughout the tax period for payment of the target tax liability. For example, each payment period or event within a tax year, the computer system can: sequester a first financial amount from a first primary spending account—affiliated with the first spouse—for payment of a first portion of the target tax liability; and sequester a second financial amount from a second primary spending account—affiliated with the second spouse—for payment of a second portion of the target tax liability. Therefore, the computer system can ensure availability of funds at an expiration of the tax year for payment of the target tax liability.

In this example, the computer system can enable each spouse to verify income and/or withholding amounts of the other spouse, with or without enabling each spouse to view individual expenses initiated by the other spouse. For example, the Therefore, the computer system enables the first and second spouses to maintain a level of privacy—selected and/or agreed to by the first and second spouse—while enabling monitoring of minimal information required to verify receipt, payment, and/or sequestration of various tax-related funds (e.g., withholding amounts, deductions, income). Additionally, the computer system can selectively reveal additional information (e.g., as described above) based on prediction and/or detection of various events, such as including a deficit and/or surplus.

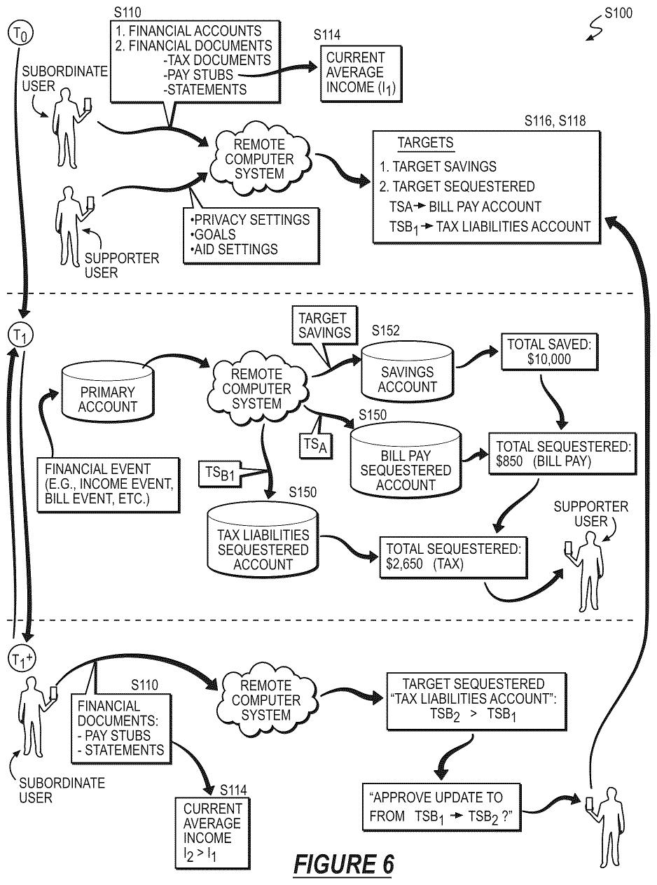

In another example, as shown in FIG. 6, the computer system can selectively enable a parent—functioning as a supporter user—to view tax information of their child functioning as a subordinate user. In particular, in this example, the computer system can selectively serve the parent tax information—based on visibility settings approved by the parent and/or child—for the child including income, deductions, tax liabilities, etc. In one example, the computer system selectively share this information with the parent based on whether the subordinate user is meeting tax goals and/or other savings or spending goals set for the subordinate user. Therefore, the computer system can enable the parent to guide the subordinate user with respect to tax management—while maintaining a level of privacy for the subordinate user—and enable the supporter user to review various financial decisions dependent on the subordinate user's tax information, such as related to tracking a target tax liability for the supporter user and/or whether to claim the subordinate user as a dependent for a particular tax period.

In yet another example, for a user(s) working multiple and/or seasonal jobs throughout a tax period, the computer system can automatically suggest and/or set withholding amounts associated with each job held by the single user throughout the tax period in order to achieve a target tax liability (or refund). In this example, during a setup period, the computer system can: serve the user a survey requesting information regarding employment for a subsequent tax period, such as whether the user intends to work multiple jobs, whether the user intends to work part time or full time, whether the user intends to work temporary or seasonal jobs, etc.; and request a set of financial documents—including income and/or tax documents—from a preceding tax period. Then, in response to receipt of the survey and the set of financial documents, the computer system can: suggest a first withholding amount for a first current job of the user; and suggest a second withholding amount for a second current job of the user. Throughout the tax period, the computer system can: request that the user update the survey and/or provide additional financial documents; and update the suggested withholding amounts accordingly in order to achieve the target tax liability.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a first financial statement of a first user of a first authority level, the first financial statement defining a first set of expenses initiated by the first user during a first time period;
extracting a first set of language signals from the first financial statement;
based on the first set of language signals:
identifying a first set of discretionary expenses in the first set of expenses; and
identifying a first set of non-discretionary expenses in the first set of expenses;
based on the first set of discretionary expenses and the first set of non-discretionary expenses, predicting a first budget deficit within a second time period succeeding the first time period; and
in response to the first budget deficit falling within a first deficit range:
identifying a first discretionary expense, in the first set of discretionary expenses, corresponding to the first budget deficit based on the first set of language signals;
generating a first electronic notification describing the first budget deficit and the first discretionary expense;
transmitting the first electronic notification to the first user; and
transmitting the first electronic notification to a second user affiliated with the first user, the second user of a second authority level exceeding the first authority level.

2. The method of claim 1:
wherein predicting the first budget deficit comprises predicting the first budget deficit within a first financial account associated with the first user; and
further comprising:
accessing a second financial statement of the first user, the second financial statement comprising a second set of expenses initiated by the first user during a second time period succeeding the first time period;
extracting a second set of language signals from the second financial statement;
based on the second set of language signals:
identifying a second set of discretionary expenses in the second set of expenses; and
identifying a second set of non-discretionary expenses in the second set of expenses;
based on the second set of discretionary expenses and the second set of non-discretionary expenses, predicting a second budget deficit within a third time period succeeding the second time period, the second budget deficit within the first financial account; and
in response to the second budget deficit falling within a second deficit range less than the first deficit range:
generating a prompt to transfer a financial amount from a second financial account, associated with the first user, into the first financial account, the financial amount corresponding to the second budget deficit; and
transmitting the prompt to the first user.

3. The method of claim 2, further comprising:
accessing a total amount of funds present in the second financial account; and
in response to the total amount of funds falling below the financial amount of the second budget deficit:
generating a request to transfer funds from a third financial account, associated with the second user, into the first financial account associated with the first user;
generating a second electronic notification describing the second budget deficit and comprising the request; and
transmitting the second electronic notification to the second user.

4. The method of claim 2:
wherein generating the prompt to transfer funds from the second financial account into the first financial account comprises generating the prompt to transfer funds from the second financial account into the first financial account, the second financial account comprising a savings account;
further comprising:
accessing a target savings amount defined for the first user during the second time period;
accessing a savings amount deposited into the savings account during the second time period;
characterizing a difference between the target savings amount and the savings amount;
in response to the second budget deficit exceeding the difference, assigning a penalty to the financial amount transferred from the savings account to the first financial account; and
appending the prompt with a notification describing the penalty; and
wherein transmitting the prompt to the first user comprises transmitting the prompt, comprising the notification describing the penalty, to the first user.

5. The method of claim 4, wherein assigning the penalty to the financial amount comprises assigning the penalty to the financial amount, the penalty defining a fixed percentage of the financial amount required for depositing into a retirement account affiliated with the first user.

6. The method of claim 1, further comprising:
accessing a second financial statement of the first user, the second financial statement comprising a second set of expenses initiated by the first user during a third time period succeeding the second time period;
extracting a second set of language signals from the second financial statement;
based on the second set of language signals:
identifying a second set of discretionary expenses in the second set of expenses; and
identifying a second set of non-discretionary expenses in the second set of expenses;
based on the second set of discretionary expenses and the second set of non-discretionary expenses, predicting a second budget deficit within a third time period succeeding the second time period; and
in response to the second budget deficit falling within a second deficit range exceeding the first deficit range:
generating a second electronic notification describing the second budget deficit and each discretionary expense in the second set of discretionary expenses; and
transmitting the second electronic notification to the second user.

7. The method of claim 1, further comprising during an initial time period preceding the first time period:
accessing a record of financial statements affiliated with the first user;
generating a recommendation for a set of privacy settings based on the record;
transmitting the recommendation to the second user for review; and
in response to receiving confirmation of the recommendation, storing the set of privacy settings in a user profile associated with the first user.

8. The method of claim 1:
further comprising, in response to the first budget deficit falling within the first deficit range, generating a request to transfer funds from a first financial account, associated with the second user, into a second financial account associated with the first user; and
wherein generating the first electronic notification describing the first budget deficit and the first non-discretionary expense comprises generating the first electronic notification describing the first budget deficit and the first non-discretionary expense and comprising the request.

9. The method of claim 1:
further comprising:
characterizing user progress based on the first budget deficit; and
in response to user progress falling below a threshold progress:
accessing a first set of privacy settings defining visibility of finances of the first user by the second user, the first set of privacy settings implemented during the first time period;
selecting a second set of privacy settings defining visibility of finances of the first user by the second user for the second time period, the second set of privacy settings configured to increase visibility of finances of the first user by the second user; and
generating a prompt to authorize replacement of the first set of privacy settings with the second set of privacy settings for implementation during the second time period; and
wherein generating the first electronic notification describing the first budget deficit and the first discretionary expense comprises generating the first electronic notification describing the first budget deficit and the first discretionary expense and comprising the prompt.

10. The method of claim 1, further comprising:
during a second time period:
accessing a second financial statement of the first user, the second financial statement comprising a second set of expenses initiated by the first user during the second time period;
extracting a second set of language signals from the second financial statement;
based on the second set of language signals:
identifying a second set of discretionary expenses in the second set of expenses; and
identifying a second set of non-discretionary expenses in the second set of expenses;
based on the second set of discretionary expenses and the second set of non-discretionary expenses, predicting a first budget surplus within a third time period succeeding the second time period; and
in response to predicting the first budget surplus:
generating a second electronic notification describing the first budget surplus; and
transmitting the second electronic notification to the second user.

11. The method of claim 10, wherein generating the second electronic notification describing the first budget surplus comprises generating the second electronic notification describing the first budget surplus and excluding description of the second set of expenses.

12. The method of claim 10:
further comprising:
characterizing user progress based on the first budget surplus; and
in response to user progress exceeding a threshold progress:
accessing a first set of privacy settings defining visibility of finances of the first user by the second user, the first set of privacy settings implemented during the second time period;
selecting a second set of privacy settings defining visibility of finances of the first user by the second user for the third time period, the second set of privacy settings configured to reduce visibility of finances of the first user by the second user; and
generating a prompt to authorize replacement of the first set of privacy settings with the second set of privacy settings for implementation during the third time period; and
wherein generating the second electronic notification describing the first budget surplus comprises generating the first electronic describing the first budget surplus and comprising the prompt.

13. The method of claim 1:
wherein accessing the financial statement comprises accessing the financial statement via a first instance of a user portal accessed by a first computing device associated with the first user; and
wherein transmitting the first electronic notification to the second user comprises transmitting the first electronic notification to the second user via a second instance of the user portal accessed by a second computing device associated with the second user.

14. The method of claim 1:
wherein predicting the first budget deficit comprises predicting the first budget deficit at a first time;
further comprising, in response to predicting the first budget deficit falling within the first deficit range:
based on a first subset of language signals in the first set of language signals, identifying a first category of discretionary expenses represented in the first set of discretionary expenses; and
generating a spending suggestion to limit spending associated with the first category during the second time period to prevent the first budget deficit;
wherein transmitting the first electronic notification to the first user comprises transmitting the first electronic notification and the spending suggestion to the first user at a first time; and
wherein transmitting the first electronic notification to the second user comprises, in response to failure by the first user to execute the spending suggestion within a first duration, transmitting the first electronic notification to the second user at a second time succeeding the first time by the first duration.

15. The method of claim 14, further comprising, in response to successful execution of the spending suggestion by the first user within the first duration, withholding transmittal of the first electronic notification to the second user.

16. A method comprising:
during a first time period:
accessing a first financial statement of a first user, the first financial statement comprising a first set of expenses initiated by the first user;
based on the first set of expenses, predicting a first budget deficit occurring during the first time period; and
in response to the first budget deficit falling within a first deficit range:
identifying a first set of discretionary expenses, in the first set of expenses, corresponding to the first budget deficit based on a first set of language signals extracted from the first financial statement;
generating a first electronic notification describing the first budget deficit and the first set of discretionary expenses; and
transmitting the first electronic notification to a second user affiliated with the first user; and
during a second time period succeeding the first time period:
accessing a second financial statement of the first user, the second financial statement comprising a second set of expenses initiated by the first user;
based on the second set of expenses, predicting a first budget surplus during the second time period; and
in response to predicting the first budget surplus:
generating a second electronic notification describing the first budget surplus and excluding description of the second set of expenses; and
transmitting the second electronic notification to the second user.

17. The method of claim 16, further comprising:
extracting the first set of language signals from the first financial statement;
based on the first set of language signals:
identifying the first set of discretionary expenses in the first set of expenses; and
identifying a first set of non-discretionary expenses in the first set of expenses;
extracting a second set of language signals from the second financial statement; and
based on the second set of language signals:
identifying a second set of discretionary expenses in the second set of expenses; and
identifying a second set of non-discretionary expenses in the second set of expenses.

18. A method comprising:
accessing an expected income defined for a first user during a first time period;
accessing a target savings amount defined for the first user during the first time period;
accessing a set of committed expenses predefined for the first time period for the first user; and
during the first time period:
at a first time, transferring the target savings amount from a primary account affiliated with the first user to a savings account affiliated with the first user;
at a second time, sequestering a first financial amount, from the primary account, allocated for payment of the set of committed expenses;
tracking a timeseries of expenses initiated by the first user;
based on the expected income, the timeseries of expenses, and a first financial amount remaining in the primary account, predicting a spending deficit of a first deficit amount at a third time, succeeding the first time and the second time, during the first time period; and
in response to predicting the spending deficit of the first deficit amount:
accessing a second financial amount remaining in the savings account; and
in response to the second financial amount remaining in the savings account exceeding the first deficit amount:
generating a prompt to transfer the first deficit amount from the savings account into the primary account;
assigning a first penalty to the first deficit amount transferred from the savings account into the primary account;
generating an electronic notification comprising the prompt and describing the first penalty; and
transmitting the electronic notification to the first user.

19. The method of claim 18:
wherein accessing the expected income defined for the first user comprises accessing the expected income defined for the first user of a first authority level; and
further comprising, in response to the second financial amount remaining in the savings account falling below the first deficit amount:
generating a second electronic notification describing the spending deficit of the first deficit amount and a subset of expenses in the timeseries of expenses;
appending the second electronic notification with a request to transfer the first deficit amount into the primary account; and
transmitting the second electronic notification to a second user affiliated with the first user, the second user of a second authority level exceeding the first authority level of the first user.

20. The method of claim 18, wherein accessing the target savings amount comprises:
based on the expected income, estimating a financial amount of tax liabilities for the first user during a global time period comprising the first time period;
accessing a savings goal defined by the first user for the global time period; and
based on the financial amount of tax liabilities and the savings goal defined by the first user for the global time period, estimating the target savings amount for the first time period.
